(19) United States
(12) Patent Application Publication
(10) Pub. No.: US 2010/0060459 A1
(43) Pub. Date: Mar. 11, 2010

(54) RFID TAG

(75) Inventors: Scott Stole, Waconia, MN (US); Tom Holsapple, Silver Lake, MN (US); Brian Bender, Victoria, MN (US)

Correspondence Address: SCHWEGMAN, LUNDBERG & WOESSNER, P.A., P.O. BOX 2938, MINNEAPOLIS, MN, 55402, US

(73) Assignee: IP B.V.Strawinskylaan, amsterdam (NL)

(21) Appl. No.: 12/208,974

(22) Filed: Sep. 11, 2008

(51) Int. Cl. G08B 13/14

(52) U.S. Cl. 340/572.8; 340/572.7

(57) ABSTRACT

An RFID Tag (10, 25, 36, 37) includes a transponder unit (29) that has at least a chip (21) and an antenna means (17) and further including a molded body (15, 27, 38, 44) for accommodating the transponder unit, the molded body being made from an elastic and deformable material.

### TECHNICAL FIELD

The present invention relates to an RFID Tag, and more particularly to an RFID Tag including a transponder unit and a molded body for accommodating the transponder unit.

### BACKGROUND

RFID Tags have up to now been widely used in various fields of application, especially in the field of recognition or identification of objects and specifically personal belongings. For example, the known RFID Tags designed for garment identification are formed as buttons or the like which have to be arranged either onto the outside of garments or textiles, or sewn into the garments or textiles, resulting in a visible witness mark and possibly interfering with the wearing comfort. As a result of the outside arrangement, some RFID Tags are readily discernible and thus disturb the outer appearance of garments or textiles being provided within the RFID Tags.

### BRIEF DESCRIPTION OF THE DRAWINGS

Embodiments of the RFID Tag are described in greater detail below with reference to the figures, whereby:

FIG. 1 shows an RFID Tag fixed on the spot;

FIG. 2 shows the RFID Tag depicted in FIG. 1 in top view;

FIG. 3 shows a cross-section of the RFID Tag shown in FIG. 2 and taken along lines III-III;

FIG. 4 shows a top view of another embodiment of an RFID Tag;

FIG. 5 is a cross-section view of the RFID Tag shown in FIG. 4 and taken along line V-V;

FIG. 6 shows a cross-section of another embodiment of an RFID Tag having a top layer and a bottom layer consisting of different materials;

FIG. 7 shows a cross-section of another embodiment of an RFID Tag having an adhesive coating covering a bottom layer of the molded body.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### OVERVIEW

Examples of the present invention can provide an RFID Tag for application in garments without creating any discomfort for the wearer of these garments and without being readily discernible.

According to an embodiment of the invention, an RFID Tag comprises a transponder unit and a molded body for accommodating the transponder unit, the molded body being made from an elastic and deformable material.

According to an embodiment of the invention, the RFID Tag features a molded body for accommodating the transponder unit and thus exhibits a sealing encapsulation preventing the RFID Tag from being damaged by humidity, for example when being subjected to a washing procedure with the garment. As a result of the elastic and deformable material chosen for manufacturing the molded body, the transponder unit being accommodated in the molded body is protected against any impacts which may occur during handling the garments. Another advantage of the elastic and deformable characteristics of the material lies in that the RFID Tags may be applied to nearly any site of the garment, since the Tag is easily adaptable to any contour of the garments. Hence, the inventive RFID Tag can, for example, be placed into a hem and fixed by an stitching action, if necessary, without creating an discomfort to the wearer.

Another effect of the aforementioned adaptation characteristics of the RFID Tag is that not only the expectations of the wearer of the garment as to aesthetics and comfort are fulfilled, but also safety and anti-theft aspects respectively are considered, since the RFID Tag cannot be noticed by any potential thief, and thus an anti-theft marker is realized without the necessity to remove the RFID Tag from the garment after sale, as is the case with the known more or less bulky embodiments of respective markers which are readily discernible fixed onto the outside of the garment, thus impairing wearing comfort.

The RFID Tag can be easily manufactured when there is a foil used as substrate for arrangement of the antenna means, the foil being accommodated within the molded body. Thus, based on the foil-mounted antenna means connected to the at least one chip, the foil serves as base unit for manufacturing the RFID Tag. Consequently, in order to complete the RFID Tag, it is only necessary to encapsulate the foil with the molding material. There are different possibilities available to produce the molded body of the RFID Tag. One approach is to have a top surface and a bottom surface of the foil covered with a top layer and a bottom layer respectively consisting of the elastic and deformable material forming the molded body.

These two covering layers can be made from the same or different materials depending on the intended characteristics.

Depending on the materials chosen for the bottom and top layers and the foil substrate respectively, it might be favorable to provide for an adhesive layer in order to achieve a reliable connection between the layers and/or the layers and the substrate.

In order to impart additional functions to the RFID-Tag going beyond the recognition or identification function according to one embodiment of the invention there is at least one intermediate layer between the foil substrate and the top layer or the bottom layer which might have for example cosmetic characteristics, i.e., flavor emitting or the like.

Another approach lies in forming the molded body homogeneously, for example by using injection molding methods, the application of which leads to an RFID Tag having the foil encapsulated.

As has turned out, an example of the present invention can include the antenna means is made from a conductive layer being arranged onto the surface of the foil. Thus, the extreme flexibility of the foil is in as little as possible interfered with the antenna means. According to an embodiment of the invention, the RFID Tag is made from an elastomer being a commonly-used and thus widely available material offering the characteristics for the material of the molded body.

In an example silicone rubber is used for the molded body, as this material has turned out to be particularly resistant to detergents.

Independently from the embodiment of the RFID Tag having a top and a bottom layer attached onto the respective surfaces of the foil or having one molded body encapsulating the foil, the present structure can have different transparencies of the outer surfaces of the top side and the bottom side, for example adapted to the color or transparency of the textiles covering the RFID tag.

### DETAILED DESCRIPTION

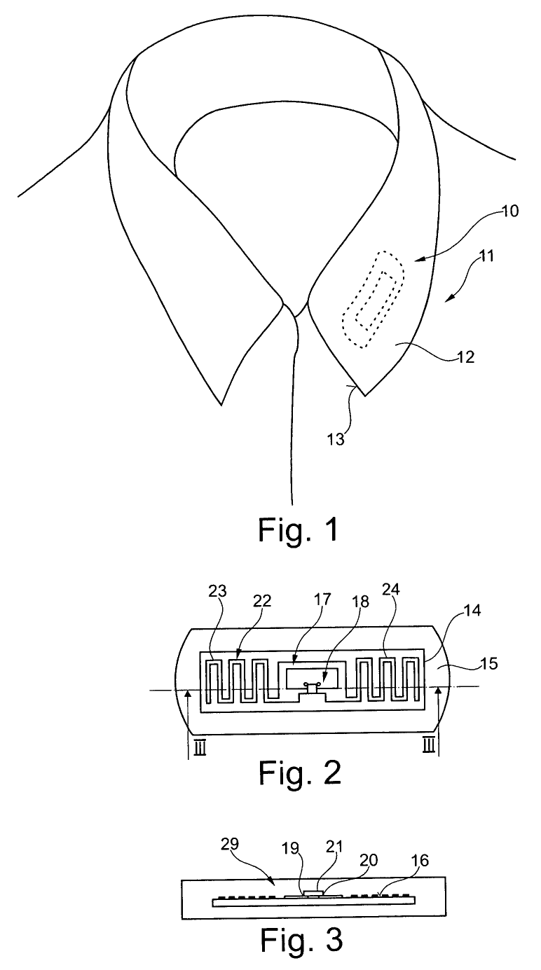

FIG. 1 shows an RFID Tag 10 fixed on the spot within a shirt collar 11, the RFID Tag being depicted with dash-dotted lines and being accommodated between two textile layers 12, 13 forming the shirt color 11.

As can be seen from a combination of FIGS. 2 and 3, the RFID Tag 10 has a foil substrate 14 accommodated within a molded body 15, the foil substrate 14 having arranged onto a top surface 16 an antenna means 17 which is here embodied as an UHF-antenna having a connection area 18 being connected with bumps 19, 20 of a chip 21. As to the depicted embodiment of the antenna means 17, the antenna means 17, is made from a conductive coating 22 arranged with two branches 23, 24 being formed as continuous reciprocating steps. As can be seen particularly from FIG. 3, the molded body 15 surrounds all sides of the foil substrate 14 and is formed as a homogeneous body made from one and the same material.

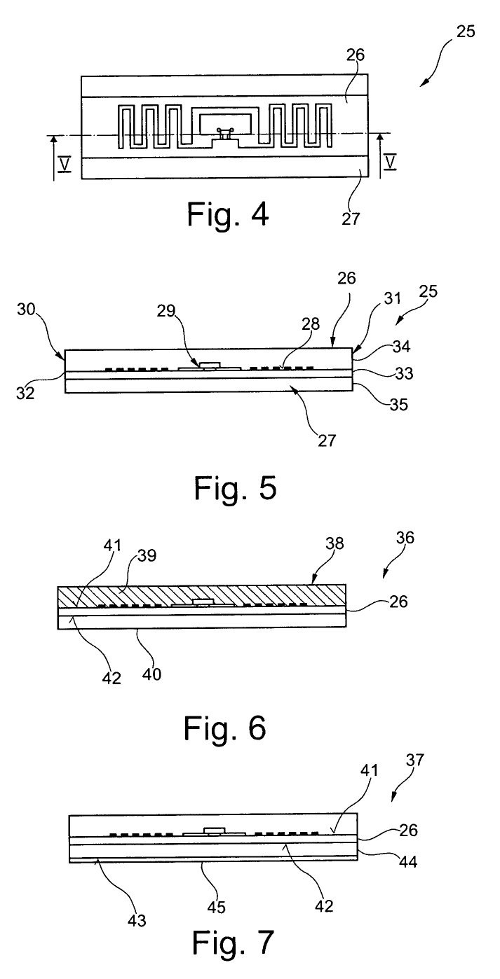

FIGS. 4 and 5 show an RFID Tag 25 having a foil substrate 26 extending over the whole length of a molded body 27 accommodating the foil substrate 26. The foil substrate 26 has arranged onto a top surface 28 a transponder unit 29 being identical to the transponder unit 29 being arranged onto the foil substrate 14 of the RFID Tag 10 depicted in FIGS. 1 to 3 and having an antenna means 17 and a chip 21.

Differing from the RFID Tag 10, the RFID Tag 25 has end faces 30, 31 of the molded body 27 having end sections 32, 33 of the foil substrate 26 flush with the end faces 30, 31 and thus parting the end faces 30, 31 in an upper end face 34 and a lower end face 35.

FIGS. 6 and 7 show as further embodiments RFID tags 36 and 37 in cross section. The RFID Tag 36 exhibits a molded body 38 differing from the molded body 27 shown in FIG. 5 in so far as the molded body 38 is composed of a top layer 39 and a bottom layer 40 each being arranged on a top surface 41 and a bottom surface 42 respectively of the foil substrate 26 being identical to the foil substrate 26 of RFID Tag 25 shown in FIGS. 4 and 5. The bottom and top layers 39 and 40 can be identical but also different in material or transparency as it is the case with the RFID-Tag 36 of FIG. 6.

The RFID Tag shown in FIG. 7 has an adhesive coating 45 applied onto a bottom surface 43 of a molded body 44. The molded body 44 can be composed of different layers or can be made homogeneous from one material covering the top surface 41 and the bottom surface 42 of the foil substrate 26 as well.

We claim:

1. An RFID Tag comprising
a transponder unit including at least a chip and an antenna; and
a molded body to accommodate the transponder unit, the molded body being made from an elastic and deformable material.

2. The RFID Tag according to claim 1, wherein the transponder unit comprises a foil substrate for arrangement of the antenna, the foil substrate being accommodated within the molded body.

3. The RFID Tag according to claim 2, wherein the foil substrate comprises a top surface and a bottom surface covered with a top layer and a bottom layer respectively comprising of the elastic and deformable material forming the molded body.

4. The RFID Tag according to claim 3, wherein the top layer and the bottom layer comprise different materials.

5. The RFID Tag according to claim 4,wherein there is at least one adhesive layer between the top layer and the bottom layer.

6. The RFID Tag according to claim 5, wherein the at least one adhesive layer is between the foil substrate and the one or both of the top layer and the bottom layer.

7. The RFID Tag according to claim 4, wherein there is at least one intermediate layer between the foil substrate and the top layer or the bottom layer.

8. The RFID Tag according to claim 7, wherein the intermediate layer has cosmetic characteristics.

9. The RFID Tag according to claim 2, wherein the molded body is formed homogeneously.

10. The RFID Tag according to claim 9,wherein the antenna is made from a conductive layer being arranged onto a surface of the foil substrate.

11. The RFID Tag according to claim 10, wherein the molded body is made from an elastomer.

12. The RFID Tag according to claim 11, wherein the molded body is made from a silicone rubber.

13. The RFID Tag according to claim 12, wherein the molded body includes a top surface and a bottom surface, the top surface and the bottom surface having different transparencies.

14. The RFID Tag according to claim 3,wherein there is at least one adhesive layer between the top layer and the bottom layer.

15. The RFID Tag according to claim 3, wherein there is at least one intermediate layer between the foil substrate and the top layer or the bottom layer.

16. The RFID Tag according to claim 1, wherein the antenna is made from a conductive layer being arranged onto a surface of the foil substrate.

17. The RFID Tag according to claim 1, wherein the molded body is made from an elastomer.

18. The RFID Tag according to claim 1, wherein the molded body is made from a silicone rubber.

19. The RFID Tag according to claim 1, wherein the molded body includes a top surface and a bottom surface, the top surface and the bottom surface having different transparencies.
